(19) United States
(12) Patent Application Publication
(10) Pub. No.: US 2004/0103292 A1
(43) Pub. Date: May 27, 2004

(54) Recording method, recording system, and reproducing system of encryption data

(75) Inventor: Go Shirouzu, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM U.S.A., INC.

(21) Appl. No.: 10/647,442

(22) Filed: Aug. 26, 2003

(30) Foreign Application Priority Data
Aug. 27, 2002 (JP) 2002-247127

(51) Int. Cl. G06F 12/14

(52) U.S. Cl. 713/193

(57) ABSTRACT

An exemplay object of the present invention is to provide an encryption data recording method, encryption data recording system, and encryption data reproducing system which do not need a specific control to handle key data and are excellent in a security protection property, and furthermore in which a person with a due access right to a recording medium can easily utilize data. The encryption data recording method is characterized in that the method is provided with a data writing step which writes encryption data in at least one recording medium using the encryption data recording system with a plurality of recording media; a key data dividing step which divides the key data of the encryption data into a plurality of key data elements; and a key data element storing step which separately stores each key data element in a plurality of the recording media.

### FIELD OF THE INVENTION

The present invention relates to, for example, a security protection technology of data recorded in a nomadic recording medium such as a magnetic tape cartridge, flexible disk, optical disk, and magnetic tape wound in a reel, in particular, to the security protection technology of data in a data recording/reproducing system with a plurality of nomadic recording media, and, in more particular, relates to an encryption data recording method, encryption data recording system, and encryption data reproducing system.

### BACKGROUND OF THE INVENTION

Conventionally, a library unit housing many magnetic tape cartridges as an external storage of a big computer system is widely known (for example, see a disclosure of WO98/59339; Japan patent laid open publication 2002-189994, pages 11 to 13, FIG. 11 in page 21, and FIG. 12 in page 22; a disclosure of WO99/26244). According to the library unit, a magnetic tape cartridge inserted in a magazine is transported to a drive by being gripped out with a robot arm and is recorded/reproduced by the drive. Because the library unit is easy to take out the magnetic tape cartridge from the magazine, for example, a data leakage due to its stealing and the like are worried. Accordingly, it is hoped that data recorded in the magnetic tape cartridge is subjected to a severe security control.

Generally as a security control technology, a method for encrypting recording data is known (for example, see Japan patent laid open 54-87072, pages 10 to 27 and FIGS. 1 to 19). The method records encryption data produced by a predetermined algorism using key data in such a recording medium as a magnetic tape and, in reproducing the recorded encryption data, it is decrypted using the key data.

So, if encryption data is recorded in a magnetic tape cartridge of a library unit, even in case that the magnetic tape cartridge is stolen, data leakage from it is avoided as far as key data is not known.

However, on the other hand, because a method for encrypting data enables anyone who can know key data to decrypt encryption data, key data control commencing with its saving is very cumbersome to heighten a data security protection property and to make it possible for a person with a due access right to a recording medium to easily utilize data

### SUMMARY OF THE INVENTION

An exemplary object of the present invention is to provide an encryption data recording method, encryption data recording system, and encryption data reproducing system which do not need a specific control to handle key data and are excellent in a security protection property for data, and furthermore in which a person with a due access right to a recording medium can easily utilize data

An encryption data recording method is characterized in that the method is provided with a data writing step which writes encryption data in at least one recording medium using a data recording system with a plurality of recording media; a key data dividing step which divides key data of the encryption data into a plurality of key data elements; a key data element storing step which separately stores each key data element in a plurality of the recording media.

According to the encryption data recording method, encryption data is recorded in at least one of plurality of the recording media, and the key data used for producing the encryption data is divided into a plurality of the key data elements and is separately stored in a plurality of the recording media.

Moreover, when reproducing the encryption data recorded by the encryption data recording method, an encryption data reproducing method is used which is provided with a data reading step which reads the encryption data written in at least one of plurality of the recording media; a key data element reading step which reads all of the key data elements from the recording media in which a plurality of the key data elements obtained by dividing the key data of the encryption data are separately stored; and a decryption step which decrypts the encryption data by producing the key data based on the key data elements and using the key data. The key data elements separately stored in the recording media are pieced together, thereby again being converted into the key data, and the encryption data is decrypted by the key data.

Thus, the encryption data recording method can be easily utilized by a person with a due access right to the encryption data, and moreover, if a recording medium in which the encryption data is recorded is stolen, the key data elements to produce the key data is separately stored in a plurality of the recording media and so the encryption data is not decrypted thereby the recording method being excellent in the security protection property.

Moreover, the encryption data recording method records the key data in a recording medium by dividing it, so the recording method can also use a sophisticated cryptography with a long key length of the key data.

Another encryption data recording system is characterized in that the system is provided with a plurality of recording media; a drive to write encryption data in the recording media; a key data element storing unit which is equipped with each of the recording media and stores key data elements divided from key data of the encryption data; and a control mechanism which produces the encryption data, produces a procedure to write the encryption data in at least one of the recording media by the drive and a plurality of the key data elements dividing key data of the encryption data, and perform a procedure to separately store the divided each key data element in each key data element storing unit of plurality of the recording media.

According to the encryption data recording system, the control mechanism divides the key data, which produces the key data elements, into a plurality of the key data elements and separately stores the divided key data elements in a plurality of the key data element storing units, so all of the key data elements composing the key data are not stored in a recording medium in which the encryption data is recorded. Thus, if the recording medium in which the encryption data is recorded is stolen, the encryption data is not decrypted, whereby the encryption data recording system of the invention is excellent in the security protection property. Moreover, the encryption data recording system separately stores the divided key data elements of the key data in a plurality of the key data storing units, so the recording system can also use a sophisticated cryptography with a long key length of the key data.

Still another encryption data recording system is characterized in that the system is provided with a plurality of recording media; a drive to write encryption data in the recording media; a key data storing unit which is equipped with each of the recording media and stores key data of the encryption data; and a control mechanism which produces the encryption data and performs procedures to write the encryption data in some of the recording media by the drive and to store the key data in the key data storing unit of any one of other recording media.

According to the encryption data recording system, the control mechanism stores the key data in a recording medium different from one in which the encryption data is written, so if the recording medium in which the encryption data is recorded is stolen, the encryption data is not decrypted, whereby the encryption data recording system of the invention is excellent in the security protection property.

### BRIEF DESCRIPTION OF THE DRAWINGS

FIG. 1 is a block diagram schematically showing a structure of a computer system with a library unit exemplified as one embodiment of encryption data recording/reproducing system of the present invention.

FIG. 2 is a perspective view exemplifying a configuration of the library unit.

FIG. 3 is a partial perspective view, partially including a cut-away portion, which shows a condition of a magnetic tape cartridge inserted in an array.

FIG. 4 is a perspective view exemplifying a structure of a cartridge memory mounted on the magnetic tape cartridge.

FIG. 5 is a flow chart exemplifying movements of a main controller, cryptography controller, and transport controller in the case that raw data is sent to the library unit from a central processing unit and key data elements are produced/saved.

FIG. 6A is a conceptual drawing showing a data structure of key data elements produced by the cryptography controller and FIG. 6B is a conceptual drawing showing a data structure of key data elements stored in a key data table.

FIG. 7 is a conceptual drawing showing a data structure of key data elements stored in a cartridge memory and a data structure of cartridge specific data.

FIG. 8 is a flow chart exemplifying movements of the main controller and cryptography controller in the case that encryption data is produced using key data.

FIG. 9 is a flow chart exemplifying movements of the main controller, cryptography controller, and transport controller in the case that a signal requesting raw data is sent to the library unit from the central processing unit and key data are produced/saved based on key data elements.

FIG. 10 is a flow chart exemplifying movements of the main controller and cryptography controller in the case that encryption data is decrypted into raw data.

### DESCRIPTION OF THE PREFERRED EMBODIMENTS

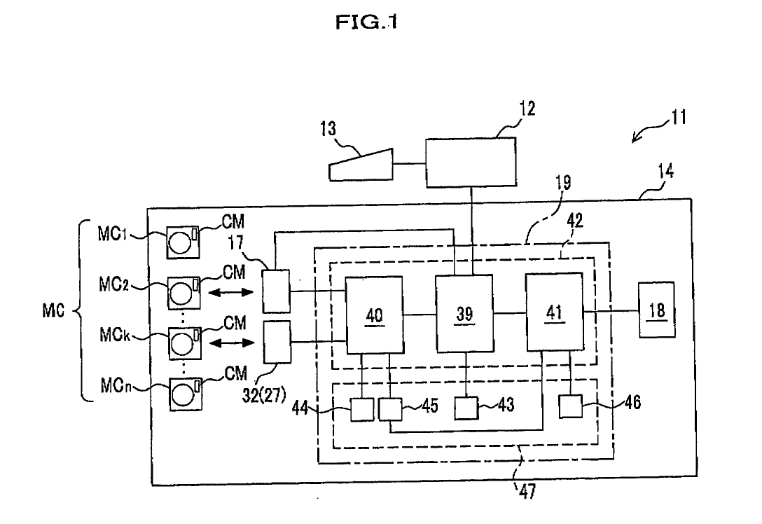

The embodiment of the present invention is described referring to drawings as needed. FIG. 1 is a block diagram schematically showing a structure of computer system with a library unit exemplified as one embodiment of encryption data recording/reproducing system of the present invention.

As shown in FIG. 1, a computer system 11 (hereinafter simply referred to as “system” in some cases) is provided with a central processing unit 12 such as a host computer, an input unit 13 such as a keyboard connecting with the processing unit 12, and a library unit 14. The system 11 is composed so that data output from the processing unit 12 corresponding to commands input from the input unit by a user of the system 11 is encrypted in the library 14, thereby being saved in a magnetic tape cartridge MC, and the encryption data saved in the magnetic tape cartridge MC is decrypted, thereby being able to be utilized in the processing unit 12. Here firstly the library unit 14 is described, and then, encryption data recording and reproducing methods using the unit 14 is described.

a. Library Unit

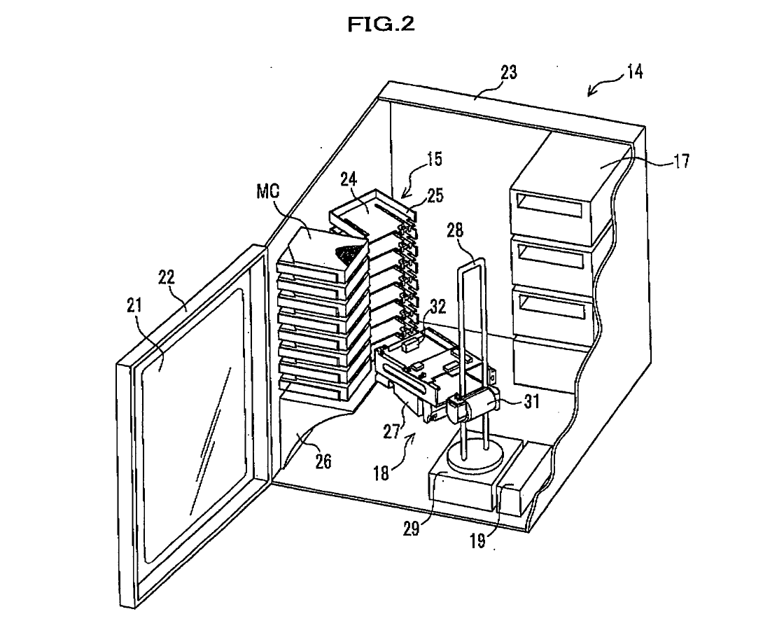

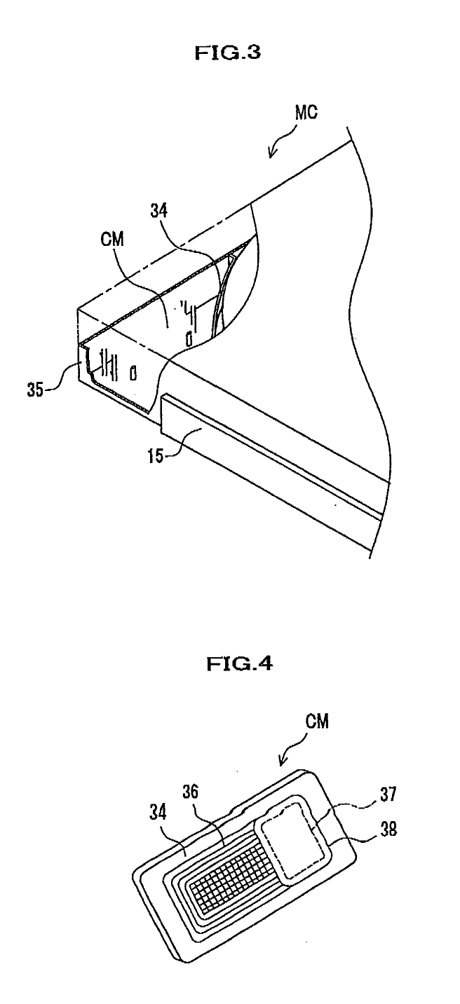

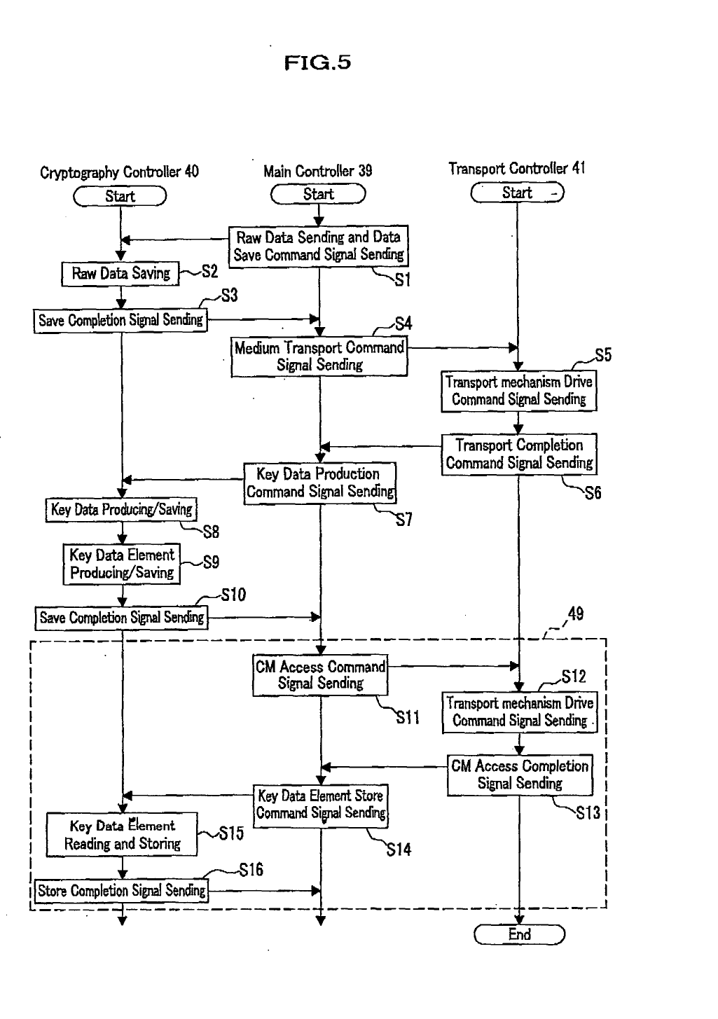

FIG. 2 is a perspective view exemplifying a configuration of a library unit, FIG. 3 is a partial perspective view, partially including a cut-away portion, which shows a condition of a magnetic tape cartridge inserted in an array, and FIG. 4 is a perspective view exemplifying a structure of a cartridge memory mounted on the magnetic tape cartridge.

As shown in FIG. 2, the library unit 14 is provided with a magnetic tape cartridge MC free-detachably inserted in each of a plurality of arrays 15, a drive 17 recording/reproducing encryption data in a magnetic tape of the magnetic tape cartridge MC, a transport mechanism 18 transporting the cartridge MC between the arrays 15 and drive 17, and a control mechanism 19 controlling recording/reproducing the encryption data and transport movements of transport mechanism 18 in the drive 17. These Arrays 15, drive 17, transport mechanism 18, and control mechanism 19 are housed in a case 23 with a door 22 in which a transparent panel 21 is fit.

The array 15 is provided with a bottom plate 24 on which a magnetic tape cartridge MC described later is placed/held and side plates 25 which vertically rise from the bottom plate 24 and enclose it from three directions, and the magnetic tape cartridge MC is designed to be inserted from front of the array 15 without the side plate 25 and be restrained from moving laterally by the side plates 25. In the embodiment, the arrays 15 are stacked in a plurality of stages and arranged in a plurality of columns on a support platform 26 placed in the case 23 so that a plurality of magnetic tape cartridges can be housed.

As the drive 17, a known one can be used and in the embodiment, as shown in FIG. 2, three sets of the drives 17 are stacked in the case 23.

As the transport mechanism 18, for example, such known mechanisms disclosed in WO98/59339, WO99/26244, and Japan patent laid open publication 2002-189994 can be used. In the embodiment, as shown in FIG. 2, the transport mechanism is composed of a robot arm 27, rail 28, turn table 29, and robot arm driving motor 31 according to a known transport mechanism.

The robot arm 27 has at its end a gripping mechanism (not shown in the drawing) which grips the magnetic tape cartridge MC inserted in the array 15 and its back-end is supported by the rail 28 vertically extending from the turn table 29 placed on a floor of the case 23 so as to be movable upward/downward through the driving motor 31. The arm 27 is provided with a cartridge detachable mechanism (not shown in the drawing) which pulls out the magnetic tape cartridge MC from the array 15 and pushes the cartridge MC in the array 15 and drive 17. Meanwhile, according to such the transport mechanism, the arm 27 swings around a predetermined rotation axis by the turn table 29 rotating and vertically moves by the driving motor 31 driving. Thus, the arm 27 grips the cartridge MC with the gripping mechanism inserted in a predetermined array 15 opposite to the transport mechanism 18, pulls out the cartridge MC from the array 15 with the cartridge detachable mechanism, and can transport the cartridge MC toward the drive 17 in case that the turn table 29 and robot am driving motor 31 are made to drive in a predetermined condition. On the contrary, the transport mechanism 18 can transport the cartridge MC inserted in the drive 17 toward the array 15 and insert it in the array 15.

Moreover, the robot arm 27 is provided with a cartridge memory interface 32 at an end opposite to the array 15 (magnetic tape cartridge MC). The cartridge memory interface 32 is subjected to remotely send/receive data at a predetermined distance to/from a cartridge memory CM of the magnetic tape cartridge MC described later. As the interface 32, for example, a known one disclosed in Japan patent laid open publication 2002-189994 can be used. In the embodiment, the interface 32 is composed of a loop antenna and modem (both not shown in the drawing) connected with the antenna.

As the magnetic tape cartridge MC, a magnetic tape cartridge according to so called LTO Standard is used and, as shown in FIG. 3, the cartridge memory CM is mounted.

The memory CM is subjected to store key data elements divided from key data which is used to encrypt and decrypt data as described later and cartridge specific data specifying the memory CM in which the key data elements are stored. Meanwhile, in the memory CM, as known well, manufacturing information of the magnetic tape cartridge MC such as a manufacturer and manufacturing number user, usage history information of a magnetic tape cartridge such as a user and usage date, and the like may be recorded.

A placed position of the cartridge memory CM is set to be at a corner of a cartridge case 35 not to impede a travel of a magnetic tape 34 and in addition, to be in the vicinity of an end protruded from front of the array 15 with the cartridge MC inserted in it.

The cartridge memory CM has, as shown in FIG. 4, a board 34 made of resin with a rectangular sheet form, a loop antenna 36 for electromagnetic induction print-wired on the board 34, and an IC chip 37 which sends/receives data (such as key data) to/from the cartridge memory interface 32 through the antenna 36. Meanwhile, the IC chip 37 is protected by being sealed in a globe top 38 formed of resin.

The control mechanism 19 is, as shown in FIG. 1, provided with a control unit 42 consisting of a main controller 39, cryptography controller 40, and transport controller 41; and a control memory 47 consisting of a main table 43, cryptography data table 44, key data table 45, and transport condition set table 46.

The main controller 39 is subjected to overall control the library 14 according to stored programs by receiving command signals from the central processing unit 12, and is composed so as to control movements of the cryptography controller 40, transport controller 41, transport mechanism 18, and drive 17 with procedures shown in an encryption data recording method and encryption data reproducing method described later.

When recording encryption data in the magnetic tape cartridge MC with procedures shown in the encryption data recording method described later, the cryptography controller 40 is composed so as to produce key data used to encrypt so called raw data before encryption, to encrypt the raw data by the key data, sends the encryption data to the drive 17 to make it be recorded, to produce key data elements described later by dividing the key data, and to send the key data elements to the cartridge memory interface 32 to store them in a predetermined memory CM. And when reproducing the encryption data in the tape cartridge MC with procedures shown in the encryption data reproducing method described later, the cryptography controller 40 is composed so as to produce the key data based on the key data elements stored in the cartridge MC and to decrypt the encryption data recorded in the tape cartridge MC into the raw data by the key data.

The transport controller 41 is composed so as to make the robot arm 27 move based on coordinate data described later stored in the transport condition set table 46 by receiving command signals from the main controller 39 and to control the gripping mechanism and cartridge detachable mechanism according to programs relating to movements of the gripping mechanism of the arm 27 and cartridge detachable mechanism also stored in the set table 46.

A cryptography data table 44 temporary memorizes the raw data and encryption data.

A key data table 45 temporary memorizes the key data produced by the cryptography controller 40, key data elements described later produced from the key data, and cartridge memory specific data described later to specify a cartridge memory CM in which the key data elements are stored.

The transport condition set table 46 stores coordinate data to specify a predetermined position in the case that the robot arm 27 accesses each magnetic tape cartridge and each drive 17, and a program relating to the movements of gripping mechanism of the arm 27 and cartridge detachable mechanism

b. Encryption Data Recording Method

Then, the encryption data recording method using the library unit 14 is described. Meanwhile, here as shown in FIG. 1, a case is described as an example, in which when n (an integer more than one) pieces of magnetic tape cartridges MC from a first magnetic tape cartridge MC₁ to a n-th magnetic tape cartridge MCₙ and the library unit 14 with one drive 17 exist, encryption data is recorded in a k-th magnetic tape cartridge MCₖ where 1≦k≦n and n is same as defined above.

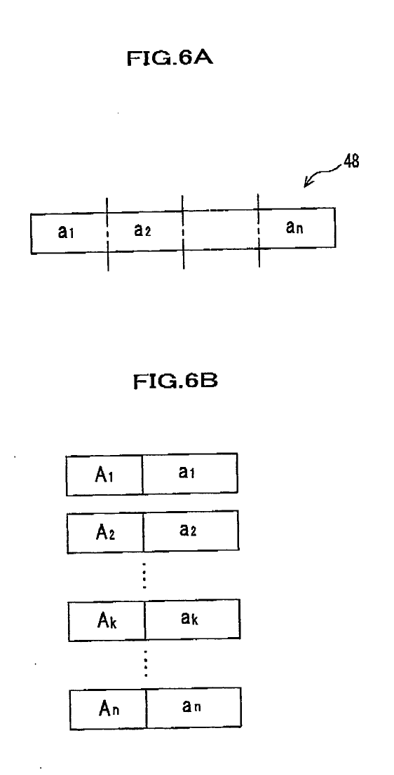

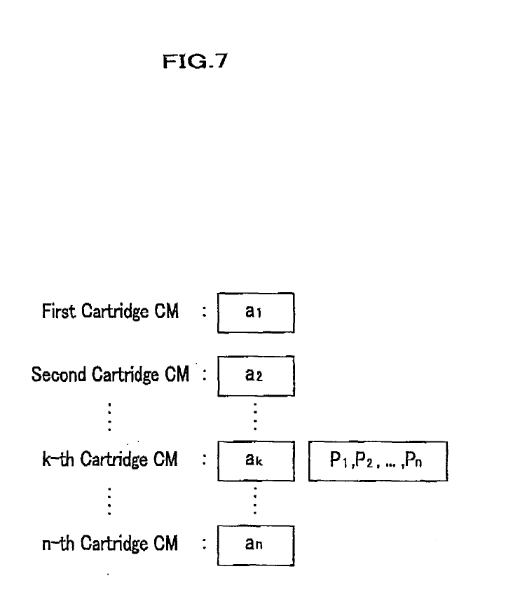

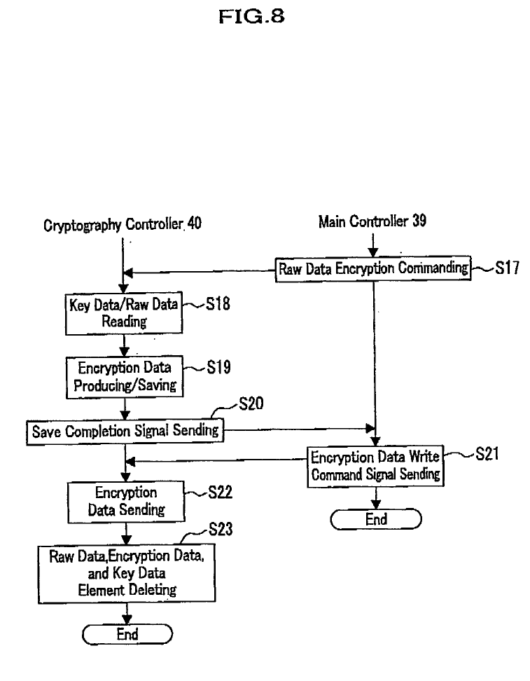

FIG. 5 is a flow chart exemplifying movements of a main controller, cryptography controller, and transport controller in the case that raw data is sent to a library unit from a central processing unit and key data elements are produced/saved. FIG. 6A is a conceptual drawing showing a data structure of key data elements produced by a cryptography controller and FIG. 6B is a conceptual drawing showing a data structure of key data elements stored in a key data table. FIG. 7 is a conceptual drawing showing a data structure of key data elements stored in a cartridge memory and a data structure of cartridge specific data. FIG. 8 is a flow chart exemplifying movements of the main controller and cryptography controller in the case that encryption data is produced using key data. Meanwhile, in FIG. 7, a CM represents a cartridge memory.

In a cryptography recording method, if raw data is sent to the main controller 39 from the central processing unit 12, as shown in FIG. 5, the controller 39 sends the raw data to the cryptography controller 40 and sends a command signal to save the raw data (S1). The controller 40 received the command signal saves the raw data in the cryptography data table 44 (S2) and sends a save completion signal to the controller 39 (S3).

The main controller 39 sends a medium transporting command to the transport controller 41 by receiving the save completion signal (S4). The transport controller 41 sends a transport mechanism driving command signal to the transport mechanism 18 so as to transport a k-th magnetic tape cartridge MCₖ inserted in the array 15 to the drive 17 (S5). If the transport mechanism 18 received the transport mechanism driving command signal completes an insertion of the k-th magnetic tape cartridge MCₖ, the transport controller 41 sends the transport completion signal to the main controller 39 (S6).

If the main controller 39 receives the transport completion signal, it sends a key data producing command signal to the cryptography controller 40 (S7). The controller 40 produces key data to encrypt the raw data and saves it in the key data table 45 (S8). As the key data producing method, a known method can be used, and as such a method, for example, a method disclosed in Japan patent laid open publication 54-87072 is cited.

Then, the cryptography controller 40 produces key data elements by dividing the key data and saves the key data elements in the key data table 45 (S9). A dividing number (X) of the key data may be set as X where X is from two to n (n; same as described before). Meanwhile, in the embodiment where X=n, that is, as shown in FIG. 6A, a key data 48 is divided into n pieces so as to allocate all the cartridge memories CM from the first magnetic tape cartridge MC₁ to the n-th magnetic tape cartridge MCₙ, thereby key data elements a₁, a₂, . . . , aₙ being produced. When saving the key data elements a₁, a₂, . . . , aₙ in the key data table 45, the cryptography controller 40 appends, as shown in FIG. 6B, identifiers A₁, A₂, . . . , Aₙ to specify an allocated cartridge memory CM to each key data element a₁, a₂, . . . , aₙ. Thus, to the each key data element a₁, a₂, . . . , aₙ in the key data table 45, the identifier A₁, A₂, . . . , Aₙ of respectively stored cartridge memories CM are appended.

Here again referring to FIG. 5, the cryptography controller 40 which saved key data elements with predetermined identifiers sends a key data save completion signal to the main controller 39 (S10).

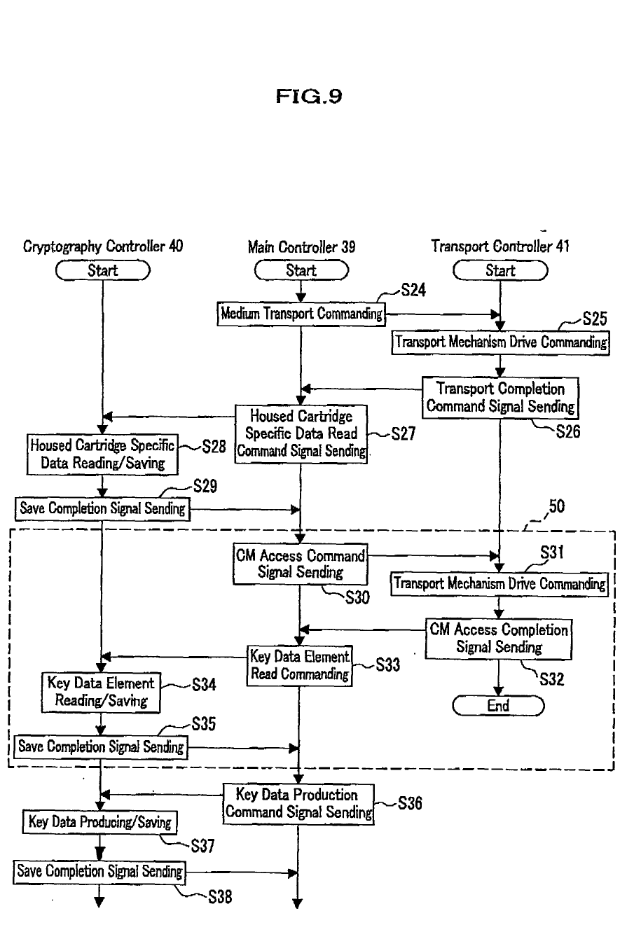

Then, the main controller 39, cryptography controller 40, and transport controller 41 repeat, as a trigger that the main controller 39 has received the key data save completion signal, next steps S11 to S16 (shown in a sign 49 in FIG. 9) times equal to a number of the cartridge memories CM in which the key data elements are stored, that is, n times.

Firstly, the main controller 39 sends a first CM access command signal to the transport controller 41 so that the cartridge memory interface 32 placed at an end of the robot arm 27 accesses a predetermined cartridge memory CM (S11). The transport controller 41 received the CM access command signal reads, for example, the key data element a₁ with the identifier A₁ (see FIG. 6B) which is saved in the key data table 45 (see FIG. 1) by referring to it.

Then, the transport controller 41 sends a transport mechanism driving command signal to move the robot arm 27 to the transport mechanism 18 so that the cartridge memory interface 32 accesses a cartridge memory CM specified by the identifier A₁, that is, the cartridge memory CM of the first magnetic tape cartridge MC₁ (S12). If the transport mechanism transports the robot arm 27 to a predetermined position and the memory interface accesses the cartridge memory CM of the first magnetic tape cartridge MC₁, the controller 41 sends a CM access completion signal to the main controller 39 (S13).

The main controller 39 received the CM access completion signal sends a key data storing command signal to the cryptography controller 40 so as to store the key data element a₁ in the cartridge memory CM of the first magnetic tape cartridge MC₁ (S14). The cryptography controller 40 reads the key data element a₁ from the key data table 45 and sends it to the cartridge memory interface 32 (see FIG. 1), thereby storing the key data element a₁ in the cartridge memory CM of the first magnetic tape cartridge MC₁ (S15). Meanwhile, the key data element a₁ sent to the memory interface 32 is stored in the IC chip 37 (see FIG.4) through the modem of the memory interface 32, loop antenna, and loop antenna 36 of the cartridge memory CM. As a transmission method between the cartridge memory CM and memory interface 32, a known method disclosed, for example, in Japan patent laid open publication 2002-189994 is available, so detailed explanation of the transmission method is omitted

Then, if storing of the key data element a₁ is completed, the cryptography controller 40 sends a storing completion signal of the key data element a₁ to the main controller 39 (S16). The main controller 39 received the completion signal sends a second CM access command signal to the transport controller 41 (S11).

The transport controller 41 received the second CM access command signal reads a key data element with an identifier except the key data element a₁, for example, the key data element a₂ with the identifier A2 (see FIG. 6B) by again referring the key data table 45 (see FIG. 1).

Then, the transport controller 41 sends a transport mechanism driving command signal to move the robot arm 27 to the transport mechanism 18 so that the cartridge memory interface 32 accesses the cartridge memory CM specified by the identifier A₂, that is, the cartridge memory CM of the second magnetic tape cartridge MC₂ (S12). Hereafter, as described before, with the steps S13 to S16 performed, the key data element a₂ is stored in the cartridge memory CM of the second magnetic tape cartridge MC₂ and a storing completion signal of the key data element is sent to the main controller 39 from the cryptography controller 40.

In the embodiment, as shown in FIG. 7, a series of steps of S11 to 16 is repeated n times, thereby the respective key data elements a₁, a₂, . . . , aₙ being stored in the first to n-th magnetic tape cartridge MC₁ to MCₙ.

Moreover, the cryptography controller 40, as shown in FIG. 7, stores cartridge specific data (P₁, P₂, . . . , Pₙ) to specify cartridge memories CM, in which the key data elements a₁, a₂, . . . , aₙ are stored, in the cartridge memory CM of the k-th magnetic tape cartridge MCₖ in which the encryption data is written. The cartridge specific data (P₁, P₂, . . . , Pₙ) is used when producing the key data from the key data elements a₁, a₂, . . . , aₙ with a cryptography reproducing method described later.

Then, if a last key data element, for example, a storing completion signal of the key data element aₙ to the n-th magnetic tape cartridge MCₙ is sent to the main controller 39 from the cryptography controller 40 (see FIG. 5), the main controller 39, as shown in FIG. 8, sends a raw data encryption command signal to the cryptography controller 40 (S17). The controller 40 received the signal reads the raw data saved in the cryptography data table 44 in the step S2 and the key data saved in the key data table 45 in the step S8 from the tables 44 and 45 (S18). The controller 40 encrypts the raw data using the read key data and saves the encryption data in the table 44 (S19). As the encryption data producing method, a known method can be used, and as such a method, for example, a method disclosed in Japan patent laid open publication 54-87072 is cited.

If saving of the encryption data is completed, the cryptography controller 40 sends a saving completion signal to the main controller 39 (S20). The controller 39 after receiving the signal drives the drive 17 (see FIG. 1) and sends an encryption data writing command signal to the controller 40 (S21). The controller 40 received the writing command signal reads cryptography data from the cryptography data table 44 and sends the encryption data to the driving drive 17 (S22). If writing of the encryption data is completed in the drive 17 by the sending, the controller 40 deletes the raw data, encryption data, key data, and key data elements saved in the tables 44 and 45 (S23). Then, with the k-th magnetic tape cartridge MCₖ being returned to a predetermined array 15 by the transport mechanism 18, the encryption data recording method terminates.

c. Encryption Data Reproducing Method

Then, the encryption data reproducing method using the library unit is described. Meanwhile, here as shown in FIG. 1, a case is described as an example, in which the encryption data recorded in the k-th magnetic tape cartridge MCₖ is decrypted according to the encryption data recording method.

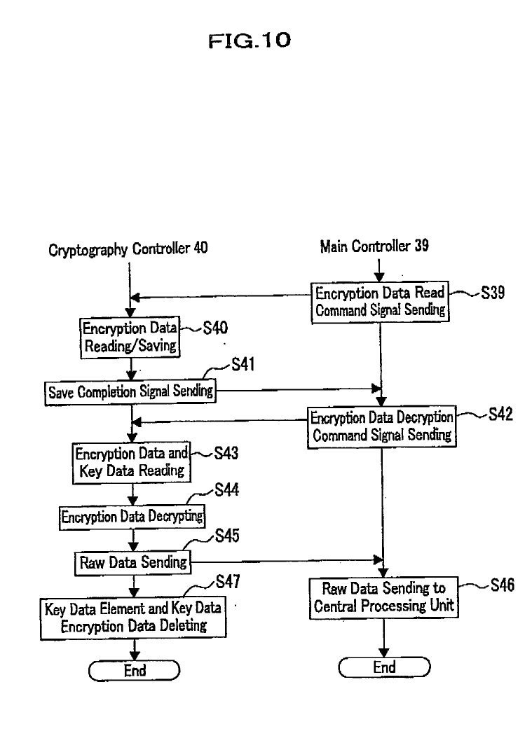

FIG. 9 is a flow chart exemplifying movements of the main controller, cryptography controller, and transport controller in the case that a signal requesting raw data is sent to a library unit from a central processing unit and key data are produced/saved based on key data elements. FIG. 10 is a flow chart exemplifying movements of the main controller and cryptography controller in the case that encryption data is decrypted into raw data.

In the cryptography reproducing method, if raw data is sent to the main controller 39 from the central processing unit 12, as shown in FIG. 9, the controller 39 sends a medium transporting command to the transport controller 41 (S24). The controller 41 receives the command signal and refers to coordinate data, thereby sending a transport mechanism driving command signal to the transport mechanism 18 in order to make it transport the k-th magnetic tape cartridge MCₖ till the drive 17 (S25). The transport mechanism 18 received the transport mechanism driving command signal transports the k-th magnetic tape cartridge MCₖ to the drive 17 and inserts the cartridge MCₖ in it. Meanwhile, then the robot arm 27 keeps a pose so that the cartridge memory interface 32 placed at the end of the arm 27 can access the cartridge memory CM. If the transport of the cartridge MCₖ is completed, the transport controller 41 sends a transport completion signal to the main controller 39 (S26).

If the main controller 39 receives the transport completion signal, it sends a cartridge specific data read command signal to the cryptography controller 40 so as to read the cartridge specific data (P1, P2 to Pₙ) stored in the step S1 (see FIGS. 5 and 7) from the cartridge memory CM of the k-th magnetic tape cartridge MCₖ(S27). The controller 40 received the read command signal reads the cartridge specific data stored in the cartridge memory CM through the cartridge memory interface 32 and saves the data in the key data table 45 (S28). Then, if saving of the cartridge specific data is completed, the controller 40 sends a cartridge specific data saving completion signal to the main controller 39 (S29).

Then, the main controller 39, cryptography controller 40, a transport controller 41 repeat, as a trigger that the main controller 39 has received the saving completion signal, next steps S30 to S35 (shown in a sign 50 in FIG. 9) times equal to a number of the cartridge memories CM specified by the cartridge specific data, that is, n times.

Firstly, the main controller 39 sends a first CM access command signal to the transport controller 41 so that the cartridge memory interface 32 placed at the end of the robot arm 27 accesses one of specified cartridge memories MC (S30). Referring to the key data table 45 (see FIG. 1), the controller 41 received the CM access command signal refers, for example, to the cartridge specific data P₁ saved in the table 45 (see FIG. 7).

Then, the transport controller 41 sends a transport mechanism driving command signal to move the robot arm 27 to the transport mechanism 18 so that the cartridge memory interface 32 of the arm 27 can access a specified cartridge memory CM specified by the cartridge specific data P₁, that is, the cartridge memory CM of the first magnetic tape cartridge MC, (S31). If the transport mechanism 18 moves the arm 27 to a predetermined position and the memory interface 32 accesses the cartridge memory CM of the first magnetic tape cartridge MC₁, the controller 41 sends a CM access completion signal to the main controller 39 (S32). The controller 39 received the completion signal sends a key data reading command signal to the cryptography controller 40 (S33). The controller 40 received the command signal reads the key data element a₁ from the cartridge memory CM of the first magnetic tape cartridge MC₁ through the memory interface 32 and saves the element a₁ in the key data table 45 (S34). Meanwhile, the key data element a₁ is read from the IC chip 37 (see FIG. 4) through the modem of the memory interface 32, loop antenna and loop antenna 36 of the cartridge memory CM.

Then, if reading and saving of the key data element a₁ are completed, the cryptography controller 40 sends a key data element saving completion signal to the main controller 39 (S35). The controller 39 received the saving completion signal sends a second CM access command signal to the transport controller 41 (S30).

The controller 41 received the second CM access command signal reads cartridge specific data except the cartridge specific data P₁, for example, P₂ from the key data table 45 by again referring to the table 45 (see FIG. 1). Then, the controller sends a transport mechanism driving command signal to move the robot arm 27 to the transport mechanism 18 so that the cartridge memory interface 32 of the arm 27 can access a specific cartridge memory CM specified by the P₂, that is, the cartridge memory CM of the second magnetic tape cartridge MC2 (S31). Hereafter, as described before, with steps S32 to S35 performed, the key data element a₂ is stored in the table 45 and a key data element storing completion signal is sent to the main controller 39 from the cryptography controller 40. In the embodiment, with a series of the steps S30 to S35 being repeated, the key data elements a₁, a₂, . . . , aₙ stored in the cartridge memories CM of the first to n-th magnetic tape cartridges MC₁ to MCₙ are saved in the table 45.

Then, if a last key data element, for example, a saving completion signal to the table 45 of key data element aₙ of the n-th magnetic tape cartridge MCₙ is sent to the main controller 39 from the cryptography controller 40, the controller 39 sends a key data producing command signal to the controller 40 (S36). The controller 40 received the command signal reads all of the key data elements a₁, a₂, . . . , aₙ from the key data table 45, produces key data by connecting these so that these are in an original order, and saves the key data in the table 45 (S37). If saving of the key data is completed, the controller 40 sends a saving completion signal to the controller 39 (S38).

If the main controller 39 receives the saving completion signal, it drives the drive 17 and, as shown in FIG. 10, sends an encryption data reading signal to the cryptography controller 40 (S39). The controller 40 receives the command signal, thereby reading the encryption data from the k-th magnetic tape cartridge MCₖ and saving the encryption data in the cryptography data table 44 (S40). If saving of the encryption data is completed, the controller 40 sends the encryption data saving completion signal to the controller 39 (S41). The controller 39 receives the saving completion data, thereby sending a encryption data decrypting command signal to the controller 40 (S42).

The controller 40 receives the decrypting command signal, and reads the key data saved in the key data table 45 in the step S 37 and the encryption data saved in the cryptography table 44 in the step S40 from the tables 46 and 44 (S43). Then, the controller 40 decrypts the encryption data using the read key data, thereby producing raw data (S44) and sending the raw data to the controller 39 (S45). Meanwhile, as the encryption data decrypting method, a known one can be used and as such the method, for example, a method disclosed in Japan patent laid open publication 54-87072 is cited.

If sending of the raw data is completed, the cryptography controller 40 deletes the encryption data, key data, key data elements, and cartridge specific data saved in the cryptography data table 44 and key data table 45 (S47). On the other hand, the main controller 39 sends the raw data to the central processing unit 12 (S46). Then, the k-th magnetic tape cartridge MCₖ is returned to a predetermined position and the encryption data reproducing method terminates.

Such the library unit 14, that is, the encryption data recording/reproducing system and the encryption data recording and reproducing methods convert raw data sent form the central processing unit 12 to encryption data by key data, records the encryption data in at least one of plurality of the magnetic tape cartridges MC, and moreover, separately stores the key data used for encrypting the data, which is divided into a plurality of key data elements, in a plurality of the cartridge memories CM.

Then, when reproducing the encryption data recorded in the magnetic tape cartridge MC, the key data elements which is separately stored is again converted to the key data and the encryption data is decrypted by the key data.

Accordingly, a person with a due access right to the encryption data recording/reproducing system can easily utilize the encryption data and moreover, if a recording medium in which the encryption data is recorded is stolen, the key data elements to produce the key data is separately stored in a plurality of recording media and the encryption data is not decrypted, thereby the security protection property being excellent.

Moreover, cartridge specific data, which is needed in producing the key data from the key data elements, to specify a storing destination of each key data element is associated with a placed position of each magnetic tape cartridge MC in the library 14 and a transport setting condition table 46 storing the position coordinate data. That is, because the cartridge specific data is unique data of the library unit 14, even in case that all the cartridge magnetic tape cartridges MC of the library unit 14 are stolen and the cartridge specific data can be obtained from a cartridge memory CM of a magnetic tape cartridge MC in which cryptography data is saved, the key data cannot be produced due to being unable to make a relationship between the key data elements needed for producing the key data and magnetic tape cartridges MC storing the key data elements. Thus, the encryption data is not decrypted.

Then moreover, cartridge memories CM of magnetic tape cartridges MC are used for key data element storing units and the cartridge memory interface 32 which sends/receives the key data elements to/from the cartridge memories CM with no contact is used for writing/reading of the key data. Because the memory interface 32 is placed at the end of the robot arm 27, only nearing the arm 27 to a magnetic tape cartridge MC makes it possible to send/receive the key data elements. Accordingly, for example, being compared with writing the key data elements in a header of a magnetic tape using the drive 17 and/or reading them from the header, writing and reading them are rapidly performed.

Furthermore, the encryption data recording/reproducing system and the encryption data recording and reproducing methods using the system enables a sophisticated cryptography with a long key length of key data to be also used even in the case that a comparatively small capacity of cartridge memories CM (about several kilo bites) because the key data elements into which the key data is divided are stored.

Thus, although the embodiment described in detail produces the key data equal to a number of the cartridge memories CM, that is, produces the key data elements divided into n pieces and stores them in all of cartridge memories CM of the first to n-th magnetic tape cartridge MC₁, . . . , MCₙ by allocating the data elements to all of the memories CM, the present invention is not limited to this on the condition that the key data is not stored in the cartridge memory of the k-th magnetic tape cartridge MCₖ in which the encryption data is recorded.

Accordingly, for example, key dividing number (X) may be set smaller than a number of the cartridge memories CM. In this case, the key data elements may be stored or not stored in the cartridge memory of the k-th magnetic tape ridge MCₖ in which the encryption data is recorded. Moreover, a plurality of key data elements may be stored in one cartridge memory CM. In the cryptography data recording/reproducing method and cryptography data recording/reproducing system in which the key data dividing number (X) is set smaller than a number of the cartridge memories CM, setting of the main controller 39, cryptography controller 40, and transport controller 41 may be altered so that a repetition number of the steps S11 to S16 (see the sign 49 in FIG. 5) and steps S20 to S35 (see the sign 50 in FIG. 9) matches a number of the cartridge memories storing the key data elements.

Still furthermore, on the condition that the key data is not stored in the cartridge memory CM of the k-th magnetic tape cartridge MCₖ in which the encryption data is recorded, the key data itself may be stored in other magnetic tape cartridges MC. Such the cryptography data recording/reproducing method and cryptography data recording/reproducing system, in the steps S11 to S16 (see sign 49 in FIG. 6) and steps S20 to S35 (see sign 60 in FIG. 9), replace reading and saving of the key data elements with those of the key data, and when the key data is stored in the step S15, setting of the main controller 39, cryptography controller 40, and transport controller 41 may be altered so that the key data is not stored in the cartridge memory CM of the k-th magnetic tape cartridge MCₖ.

In these embodiments, although the library unit 14 storing the key data and key data elements in the cartridge memories of the magnetic tape cartridges MC is described as an example, the invention may be composed so as to use nomadic recording media such as a flexible disk, optical disk, optical tape and magnetic tape wound in a reel in stead of the magnetic tape cartridge MC and to store the key data and key data elements in headers of these recording media.

What is claimed is:

1. An encryption data recording method comprising the steps of:
a data writing step writing encryption data in at least one of recording media, using a data recording system with a plurality of the recording media;
a key data dividing step dividing key data of said encryption data into a plurality of key data elements; and
a key data element storing step separately storing divided each key data element in a plurality of the recording media.

2. An encryption data reproducing method which reproduces encryption data recorded with an encryption data recording method according to claim 1, the reproducing method comprising the steps of:
a data reading step reading encryption data written in at least one of plurality of recording media;
a key data element reading step reading all said key data elements from said recording media in which a plurality of key data elements obtained by dividing key data of said encryption data are separately stored; and
a decrypting step producing said key data based on said key data elements and decrypting said encryption data using the key data.

3. An encryption data recording method comprising the steps of:
a data writing step writing encryption data in part of recording media, using a data recording system with a plurality of recording media; and
a key data storing step storing key data of said encryption data in any one of other recording media.

4. An encryption data reproducing method which reproduces encryption data recorded with an encryption data recording method according to claim 2, the reproducing method comprising the steps of:
a data reading step reading encryption data written in at least one of plurality of recording media; and
a decrypting step reading said key data from any one of other recording media in which key data of said encryption data is stored and decrypting said encryption data, using the key data.

5. An encryption data recording system comprising:
a drive which writes encryption data in a plurality of recording media and said recording medium;
a key data element storing unit which is provided with each said recording medium and stores key data elements into which key data of said encryption data is divided; and
a control mechanism comprising the steps of producing said encryption data and writing said encryption data in at least one of plurality of said recording media by said drive, and producing a plurality of the key data elements by dividing key data of said encryption data, and separately storing divided each key data element in each key data element storing unit.

6. An encryption data reproducing system which reproduces encryption data recorded by an encryption data recording system according to claim 5, the reproducing system comprising:
a drive which reads encryption data from a plurality of recording media and said recording medium;
a key data element storing unit which is provided with each said recording medium and stores key data elements into which key data of said encryption data is divided; and
a control mechanism comprising the steps of reading said encryption data written in said recording medium by said drive and reading all said key data elements separately stored in said each key data element storing unit, and producing the key data based on the read each key data element and decrypting said encryption data using the key data.

7. An encryption data recording system comprising:
a drive which writes encryption data in a plurality of recording media and said recording medium;
a key data element storing unit which is provided with each said recording medium and stores key data of said encryption data; and
a control mechanism comprising the steps of producing said encryption data and writing said encryption data in part of plurality of said recording media by said drive, and storing said key data in said key data storing unit of any one of other recording media

8. An encryption data reproducing system which reproduces encryption data recorded by an encryption data recording system according to claim 7,
which the reproducing system reproduces the encryption data recorded in part of plurality of recording media using key data stored in any one of other recording media, the reproducing system comprising:
a drive which reads from said recording medium, and a key data element storing unit which is provided with said recording medium and stores the key data of said encryption data; and
a control mechanism comprising the steps of reading said encryption data written in said recording medium by said drive and reading the key data stored in said key data element storing unit, and decrypting said encryption data using the key data.

9. An encryption data recording system according to claim 5, wherein said recording medium is a magnetic tape.

9. An encryption data recording system according to claim 5, wherein said recording medium is a magnetic tape.

10. An encryption data reproducing system according to claim 6, wherein said recording medium is a magnetic tape.

11. An encryption data recording system according to claim 7, wherein said recording medium is a magnetic tape.

12. An encryption data reproducing system according to claim 8, wherein said recording medium is a magnetic tape.

13. An encryption data recording system according to claim 5, wherein said recording medium is a magnetic disk.

14. An encryption data reproducing system according to claim 6, wherein said recording medium is a magnetic disk.

15. An encryption data recording system according to claim 7, wherein said recording medium is a magnetic disk.

16. An encryption data reproducing system according to claim 8, wherein said recording medium is a magnetic disk.

17. An encryption data recording system according to claim 5, wherein said recording medium is an optical recording disk.

18. An encryption data reproducing system according to claim 6, wherein said recording medium is an optical recording disk.

19. An encryption data recording system according to claim 7, wherein said recording medium is an optical recording disk.

20. An encryption data reproducing system according to claim 8, wherein said recording medium is an optical recording disk.
